(19) United States
(12) Patent Application Publication
(10) Pub. No.: US 2006/0087634 A1
(43) Pub. Date: Apr. 27, 2006

(54) Dynamic illumination uniformity and shape control for lithography

(76) Inventors: Jay M. Brown, Dallas, TX (US); Koichi Matsumoto, Tokyo (JP)

Correspondence Address: MCGUIREWOODS, LLP, 1750 TYSONS BLVD, SUITE 1800, MCLEAN, VA, 22102, US

(21) Appl. No.: 10/971,675

(22) Filed: Oct. 25, 2004

(51) Int. Cl. G03B 27/72

(52) U.S. Cl. 355/69; 355/53

(57) ABSTRACT

A subsystem for an exposure apparatus has at least one array of tilting mirrors placed in either an image reticle plane or a conjugate image plane to provide dynamic control of an illumination beam through an exposure field. In the system, an optical subsystem and a plurality of mirrors directs light to a reticle and a sensor senses the illumination distribution of the light at a wafer stage. When the at least one array of tilting mirrors is placed in the image reticle plane, a control is used to interpolate data of the illumination distribution sensed by the sensor, and then control movement of at least one mirror of the array of mirrors based on the interpolated data.

### BACKGROUND OF THE INVENTION

1. Field of the Invention

The invention generally relates to a system and method for providing illumination uniformity and shape control using lithographic tools and, more particularly, to a system and method which dynamically reduces illumination non-uniformity and provides flexibility in shape control across an exposure field using lithographic tools.

2. Background Description

A lithographic tool uses many components such as, for example, reticles, optical subsystems, apertures and a host of other subsystems to ensure precise image transfer onto a wafer to produce a desired microelectronic device. But, the ability to produce high quality microelectronic devices and reduce yield losses is dependent on the control of the illumination uniformity and shape control of the light being projected from the lithographic tool over an exposure field. That is, (i) illumination uniformity (i.e., brightness) may affect the image quality projected onto the wafer due to varying brightness of the projected light and (ii) illumination shape (source shape) may affect the image patterned onto the wafer.

By way of example, in known systems, the projection of light onto a wafer is not always uniform due to illumination drift and other known variations in the optics and projection system of a lithographic tool. In some instances, for example, a light source has a bright center and dark edges, or the opposite. In one type of system, to correct illumination variances, certain optical subsystems are used within the lithographic tool. For example, in these known systems, illumination uniformity may be controlled by optics referred to as “fly eyes” which are an array of lenses packed together, resembling a honeycomb. As light is emitted into one end of this system, each lens projects that image to the same place, which then results in an average of the brightness. This is an attempt to eliminate any inconsistencies in the illumination to thus “smooth” out the projected light.

In the short run, such systems are effective in controlling the illumination uniformity. However, such as system may pose long term problems. For example, this type of optical system (e.g., fly's eye) is ideal for its designed parameters, but cannot compensate for changing characteristics of the system such as, for example, uniformity drift of the illumination intensity over an exposure field over time. This drift will ultimately reduce the effectiveness and efficacy of the entire lithographic system; that is, the optical system is incapable of adapting to new parameters and will result in non-uniform illumination.

In some instances, to compensate for this reduced efficiency, a mask such as, for example, a relay lens may be used to further control the brightness of the light, e.g., illumination uniformity. In this type of example, the lens is specifically designed for the illumination intensity of the system, at a given time. This is accomplished by measuring the illumination intensity at the wafer stage and specifically designing a mask to compensate for bright spots. In such a design, the mask, e.g., piece of glass, will include shaded areas to compensate for the bright spots in the illumination path. Accordingly, the shaded areas, preferably, are designed to eliminate the brighter spots of the illumination beam in order to “smooth” out the illumination intensity over the exposure field.

By way of a specific example, it may be known through a reading of a pinhole sensor at the wafer stage that the illumination is brighter at the center of the image than at the edges. In this case, a lens would be specifically designed in order to have a shaded area in the center to compensate for the brighter center. But, in such a design, much like the use of the “fly eyes” optical system, the lens remains static and cannot adjust to further changes in the illumination pattern, which tends to drift over time, i.e., the center might continually get brighter and brighter. So, in these cases, a new mask would have to be designed and placed in the system to compensate for such illumination drift. This, of course, increases downtime of the system, while also increasing maintenance and labor costs.

In addition, lithographic tools also control the shape of the illuminated light in order to pattern the wafer. This process is typically performed by an array of fixed apertures and a variable iris control of the source shape. However, since these lenses are of fixed shape, the pattern can only be shaped into a finite amount of patterns, matching to each of the fixed apertures. Accordingly, to change a pattern, the fixed apertures must be removed, and then new aperture patterns must be designed and installed onto the system. This, again, limits the flexibility of the system, increases overhead costs and, in some instances, will increase the downtime of the entire system.

### SUMMARY OF THE INVENTION

In a first aspect of the invention, a subsystem for a lithographic tool has at least one array of controllable tilting mirrors placed in either an image reticle plane or a conjugate image plane to provide dynamic control of an illumination beam through an exposure field.

In another aspect of the invention, the subsystem for a lithographic tool includes an optical subsystem and a plurality of mirrors directing light to a reticle, and an array of tilting mirrors placed in an image reticle plane of the light. A sensor is provided for sensing the illumination distribution of the light at a wafer stage and a control interpolates data of the illumination distribution sensed by the sensor. The control controls movement of at least one mirror of the array of mirrors based on the interpolated data.

In still another aspect of the invention, a subsystem for a lithographic tool includes an optical subsystem and a plurality of mirrors directing light to an exposure field. An array of tilting mirrors is placed in a conjugate image plane of the light. The mirrors control the source shape to modulate the frequency plane of an image.

In yet another aspect of the invention, a method for reducing illumination non-uniformity includes illuminating an exposure field with light and measuring brightness of the light throughout the exposure field. The method also includes interpolating the measured brightness to provide data of illumination uniformity over the exposure field. At least one mirror element is adjusted based on the data to thereby manipulate the light and reduce illumination non-uniformity.

The invention also includes an exposure apparatus comprising an illumination system that projects radiant energy on a reticle R that is supported by and scanned using a wafer positioning stage. At least one linear motor positions the wafer positioning stage. At least one array of tilting mirrors is placed in either an image reticle plane or a conjugate image plane to provide dynamic control of an illumination beam through an exposure field.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows a diagram of an embodiment in accordance with the invention;

FIG. 2 shows an exploded view of a micro-mirror array used in accordance with the invention;

FIG. 3 shows an exploded view of an embodiment of the invention;

FIG. 4a shows an illumination graph according to an embodiment of the invention;

FIG. 4b shows an illumination graph after “smoothing” of the illumination over an exposure field according to an embodiment of the invention;

FIG. 5 shows a flow chart of steps in accordance with implementing the invention;

FIG. 6 shows a diagram of another embodiment in accordance with the invention;

FIG. 7 shows several example source shapes created in accordance with the invention;

FIG. 8 is a schematic view illustrating a photolithography apparatus according to the invention;

FIG. 9 shows a flow chart of manufacturing device; and

FIG. 10 shows a flow chart of manufacturing a device.

### DETAILED DESCRIPTION OF EMBODIMENTS OF THE INVENTION

The invention is directed to, for example, improving an imaging quality across the exposure field using one or more micro-mirror devices. In one embodiment, the system and method allows for a reduction in illumination non-uniformity across the exposure field and dynamic control through the exposure scan. This system and method can thus compensate for a wide variety of illumination non-uniformity signatures across the illumination field as well as dynamic illumination control during the exposure scan, while supporting real-time uniformity feedback control (e.g., continuously adjustable feedback control). In further embodiments, the system of method of the invention functions as a variable aperture with a great degree of flexibility in the definition and use of source shapes for resolution enhancement. This function can eliminate the need for fixed apertures. According, the systems and methods of the invention will greatly increase the efficiency and accuracy of the lithographic tool, while also decreasing down time and maintenance costs.

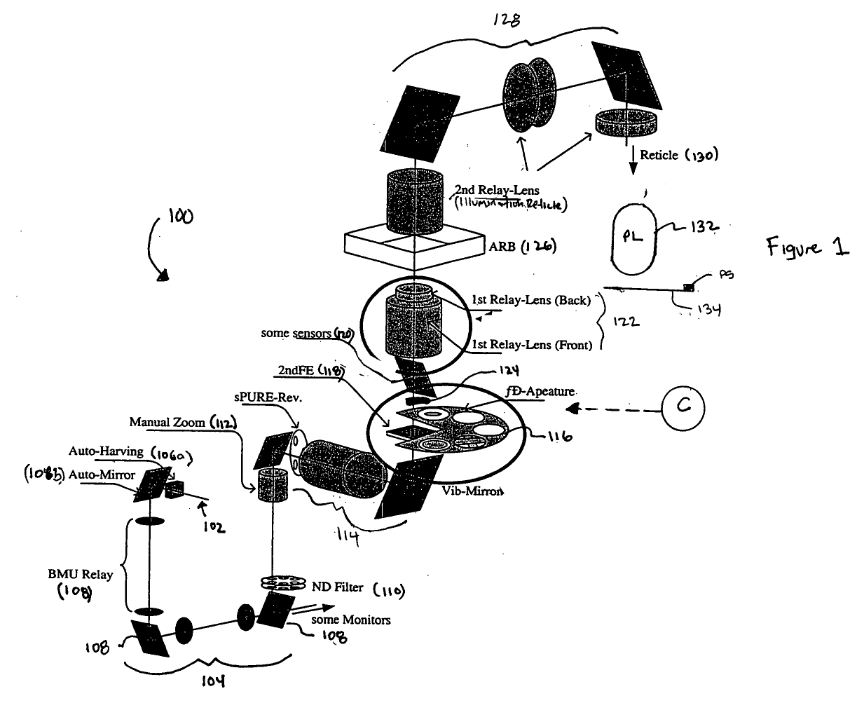

FIG. 1 shows a lithographic tool in accordance with one embodiment of the invention. The lithographic tool includes an array of mirrors, masks and optical systems, generally denoted as reference numeral 100. It should be understood by those of ordinary skill in the art that the lithographic tool of FIG. 1 is only one illustrative example used for purposes of discussion, and that the invention should not be limited to this specific configuration. In other words, it is contemplated herein that other lithographic tools can equally be used and adapted for use in accordance with the principles of the invention, as described below.

As a general overview of the lithographic tool of FIG. 1, light 102 is emitted from a high power laser and is pulsed through an array of optics and mirrors shown generally as reference numeral 104, all well known in the art to those of skill. For example, the pulsed light is projected through, for example, (i) an auto-harving 106a, (ii) an auto mirror 106b, (iii) a BMU relay (beam manipulation unit) 108, (iv) and mirrors 108.

After being reflected by the mirrors, the light is passed through a neutral density (ND) filter 110. In one embodiment, the ND filter 110 includes six (6) slots and may be used as a first attempt to control the light intensity; that is, the ND filter 110 is a fixed set of lens which allows a certain amount of light to enter through, depending on the specific slots which are aligned with one another. In one implementation, the ND filter 110 may allow 100% to 15% of light to pass through differently aligned slots by turning the wheels and alignment of certain slots of the ND filter. The ND filter 110 thus provides more flexibility to the system in an attempt to control overall brightness of the light at the reticle; however, the ND filter 110 does not change the brightness within the field.

Still referring to FIG. 1, the light may then pass through a manual zoom 112, which expands the light to fit the upcoming field. Once the light passes through the manual zoom 112, it will then pass through additional optics, shown generally as reference numeral 114. These optics 114 may include a sPURE enhancer (e.g., super power up resolution enhancer), which shapes the beam of light to one of the different options on the fixed wheel turret 116, e.g., fixed aperture and variable iris control for source shape, used in one embodiment of the invention. At this stage and preferably prior to the fixed wheel turret 116 is a fixed fish eye lens 118, well known to those of skill in the art.

In one embodiment, a sensor 120 is positioned between the fixed wheel turret 116 and a first relay lens 122. The first relay lens 122 may include two lenses: a front lens and back lens. The sensor 120 senses the illumination intensity or power to determine the required exposure time needed to obtain a desired illumination at the reticle. The relay lens 122 may be used to assist in control of illumination uniformity.

In accordance with the invention, a digital micro-mirror device 124 (referred to as a DMD) may be positioned between the fixed wheel turret 116 and the sensor 120, in the image reticle plane, to dynamically provide a reduction in illumination non-uniformity across the exposure field and to dynamically control the illumination through the exposure field, while supporting continuously adjustable uniformity feedback control. As discussed in more detail below, the micro-mirror array 124, through control, can compensate for illumination drift without the need to redesign mask lenses.

In embodiments, the micro-mirror array 124 may be positioned before the sensor 118; though, it should be understood that the placement of the micro-mirror array may equally be positioned between (i) the sensor 120 and the relay lens 122 or (ii) the front and rear lenses of the relay lens or other location within an image reticle plane. However, by placing the micro-mirror array prior to the sensor 120, the sensor 120 can sense an accurate illumination intensity in order to adjust for a desired exposure time needed to obtain a desired illumination at the reticle.

The micro-mirror array 124, in one application, is in the reticle image plane and includes an array of adjustable mirrors which can compensate, under control and feedback, the illumination intensity over the entire illumination field used to pattern an image on a wafer surface. In other words, the micro-mirror array 124 can dynamically adjust to compensate for any uniformity drift in illumination intensity to reduce illumination non-uniformity.

FIG. 1 shows additional subcomponents of the lithographic tool such as, for example, the automatic reticle blind (ARB) 126. As should be well understood by those of skill in the art, the ARB is used to control the size of the print by masking off the edges so that they are crisp and clean, e.g., control the size of the image printed. An array of mirrors and lens, shown as reference numeral 128, includes, for example, a second relay lens system. The second relay lens system and array of mirrors directs the light to a reticle 130 which is used to provide a print pattern on the wafer. The reticle 130 then projects the desired image through a projection lens 132 and then onto a wafer placed on a wafer stage 134.

A pinhole sensor “PS” may be placed on the wafer stage 134 to measure the illumination intensity at several locations. This may be performed by moving the sensor PS on a stage or other mechanism, as is well known in the art. The sensor PS will provide feedback to a controller “C”, in communication with the components of the system. The controller “C” can then use this feedback to adjust and/or control the micro-mirror, amongst other components and the like, to reduce the illumination non-uniformity over the exposure field.

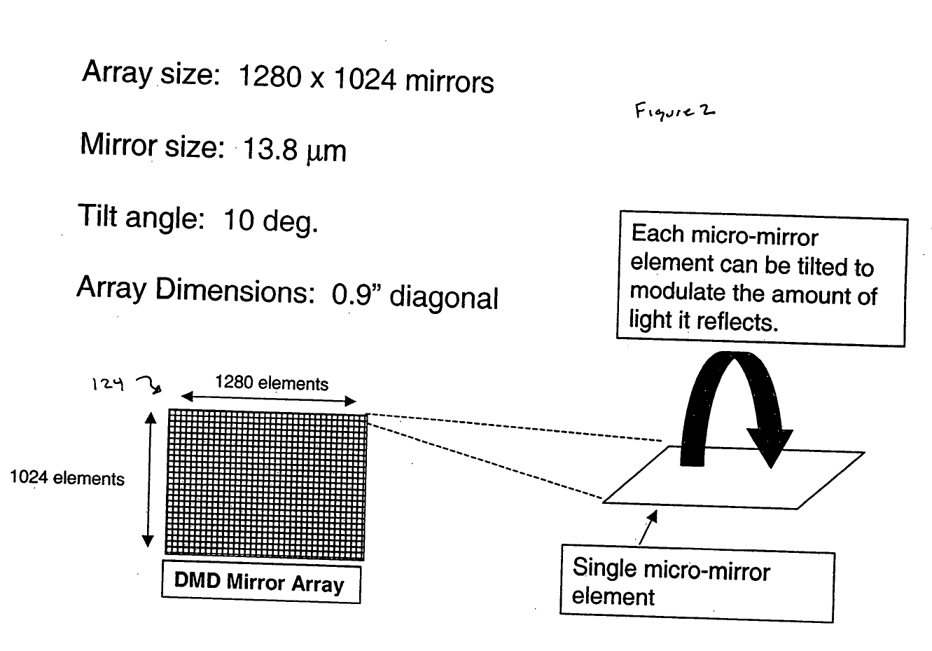

FIG. 2 shows an embodiment of the micro-mirror array used in accordance with the invention. The micro-mirror array of FIG. 2 is one exemplary embodiment, of which other configurations are also contemplated for use with the invention. For example, the micro-mirror array shown and described in U.S. Pat. No. 4,698,602 (which is incorporated by reference in it is entirety) may be used with the lithographic tool. In the micro-mirror array shown in FIG. 2, an array of 1280 by 1024 mirror elements is shown. In one embodiment, the mirror size is 13.8 μm and the tilt angle is 10 degrees. The array has an approximate 0.9 inch diagonal.

In use, each individual mirror element is adjustable by tilting via any known control. By tilting each mirror individually, it is now possible to modulate the amount of light reflecting from each element in order to adjust the intensity of the illumination. So, by example, when it is determined that that there is a bright spot within the illumination field, a mirror or mirrors of the micro-mirror array corresponding to the bright spot may be tilted to a certain tilt angle for a certain time period in order to reflect the light away from the optics. In this manner, this light will not shine through to the reticle and projection lens. This, in turn, will create a darker illumination density or distribution at these locations within the illumination field. By tilting the mirrors for a predetermined period of time and at a predetermined speed, it is also possible to make gray scale adjustments in the illumination field to adjust for any sensed bright spots. In this way, the illumination field may be dynamically adjusted in order to improve illumination uniformity and hence the image pattern.

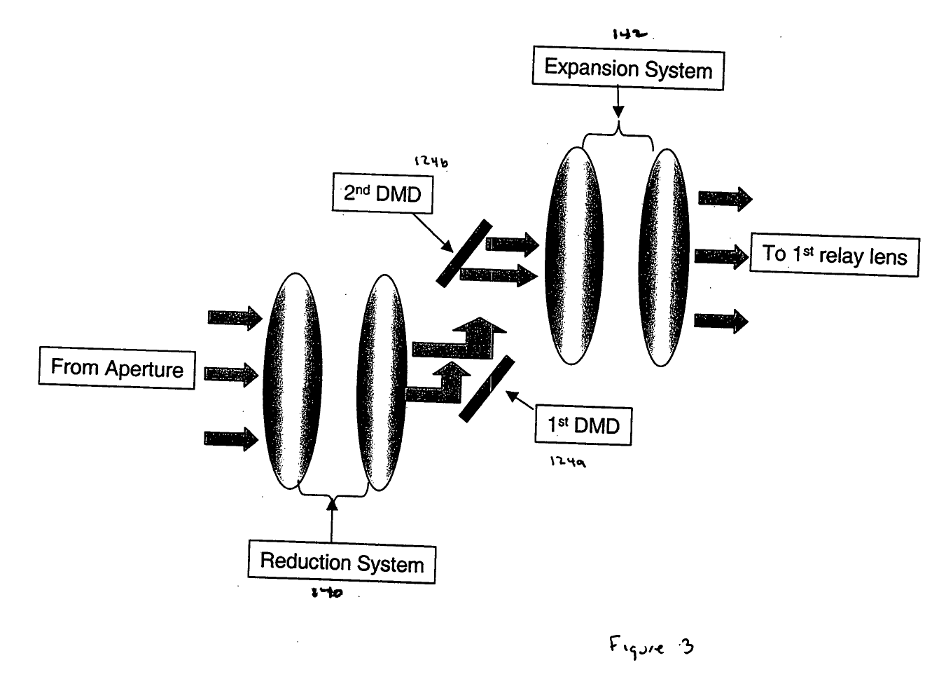

FIG. 3 shows an embodiment of the invention utilizing a two micro-mirror array configuration. In this embodiment, a first micro-mirror array 124a is positioned after a reduction system 140 and a second micro-mirror array 124b is positioned before an expansion system 142. The light emitting through the expansion system 142 will be reflected to the first relay lens 122. In this embodiment, the reduction system 140 is used to reduce the light beam from the fly's eye in order to fill up the micro-mirror. Then, at the back end of the system, the expansion system 142 will enlarge the light beam to fill up the first relay lens. Thus, if fitting is required, the use of the reduction system and the expansion system ensures that all of the available light is utilized by the micro-mirror array and the relay lens. It should also be understood that the reduction system and the expansion system may be reversed, in embodiments, depending on the parameters of the system.

By using two micro-mirrors, it is possible to provide an alignment with the reduction system 140 and the expansion system 142, without requiring any reconfiguration of the system. That is, the optical path can be aligned between the reduction system 140 and the expansion system 142, or other components in the lithographic tool. Additionally, control of the beam cross section uniformity can be increased by moving the mirror elements in each of the micro-mirrors 124a, 124b. Additionally, by using two mirror arrays, response times can be increased, if adjustment by one mirror cannot provide a fast enough response time.

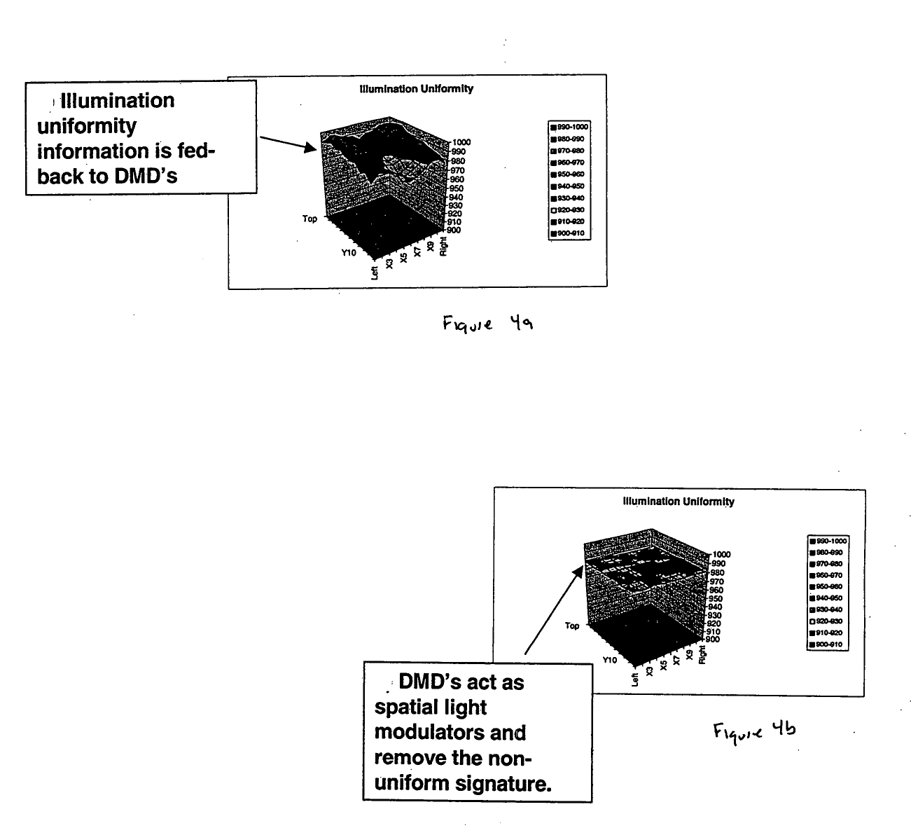

FIGS. 4a and 4b show an illumination graph according to an embodiment of the invention. The plotting of data as shown in FIGS. 4a and 4b into 3-dimensional illumination graphs is well known to those of skill in the art and can be derived in various ways without the need for discussion. Additionally, the illumination intensity data originally plotted in FIG. 4a and as is converted in FIG. 4b is only one example in accordance with the invention. Accordingly, it should be recognized that these plots are not to be construed as limitations on the invention and that the invention can equally be practiced with any plotted illumination uniformity data.

In FIG. 4a, a three dimension plot of illumination uniformity at the exposure field is shown resulting from a uniformity drift in the illumination intensity, for example. As shown in this plot, a measured brightness is shown in the right, left and lower middle portion of the illuminated pattern (e.g., illumination field). This measured brightness may be sensed by the pinhole sensor, discussed above.

FIG. 4b shows a resultant illumination graph after adjustment of the illumination intensity via the micro-mirror array. That is, by using the data of FIG. 4, the controller “C” can interpolate the information and adjust (e.g., tilt) the mirror elements of the micro-mirror array at the locations corresponding to the bright spots. This adjustment, in turn, will result in reflecting light away from the projection lens and thus the exposure field.

The measured brightness and corresponding control of the mirror(s) can be provided periodically, in a continuous feedback control loop, such as, for example, every batch or upon the determination that a uniformity drift in illumination intensity has occurred. The control is provided via, in one embodiment, a feedback loop established between the controller “C” and the pinhole sensor “PS” to provide the brightness information to the controller “C’. In this manner, the bright spots can be toned down or smoothed to better match the darker illumination field; that is, the micro-mirror array can be used to reduce illumination non-uniformity across the exposure field.

In embodiments, one or more mirror elements of the micro-mirror array corresponding to the bright spots can be tilted for a predetermined amount of time, depending on the sensed bright spots, under control of the controller “C”. By having one or more mirror elements tilt (e.g., on and off) during a certain cycle for defined times, based on the brightness information of FIG. 4a, for example, the system can now provide a gray scale to further adjust illumination distribution within the illumination field, (i.e., 32 different settings can essentially provide 32 gray scales or eight levels of brightness for each mirror element of the micro-mirror array). By using this process, the signature of the illumination field will flatten as shown in FIG. 4b.

By way of an illustrative example, using a brightness control range of 25%, in one implementation, to “process a new page” or refresh the entire array takes 100 microseconds (100 e-6 sec per update). Assuming that the scanner has a scan speed of 300 mm/s and an imaging slit length is 8 mm, a scan of the slit length can be accomplished in 26.7 milliseconds (8 mm/(300 mm/s)=26.7 e-3 sec). This translates into a mirror array update of about 266 times during the scan time (26.7 e-3 sec/(100 e-6 sec per update)=266 changes). So, in this example, the mirror can provide about 266 “gray scale” levels. If, for example, a correction for up to 25% non-uniformity in the illumination is desired, then the resolution of the uniformity adjustment is about 0.1% (25/266=0.094), which is significantly better than previous control of the non-uniformity to be in the range of about 1.2% or 1.0%.

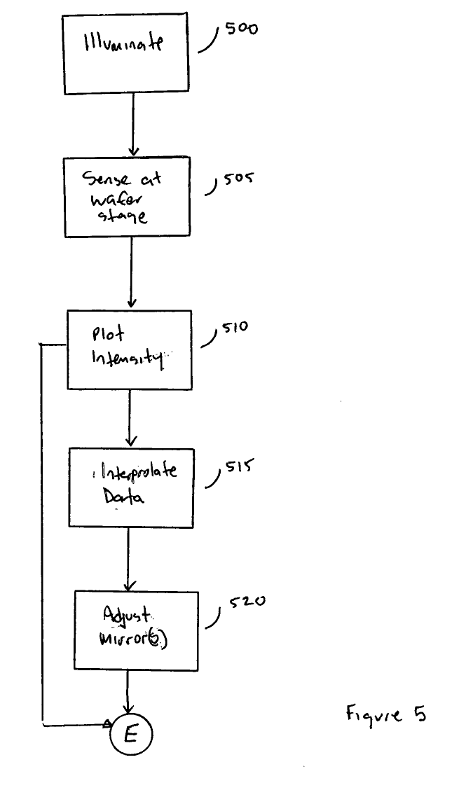

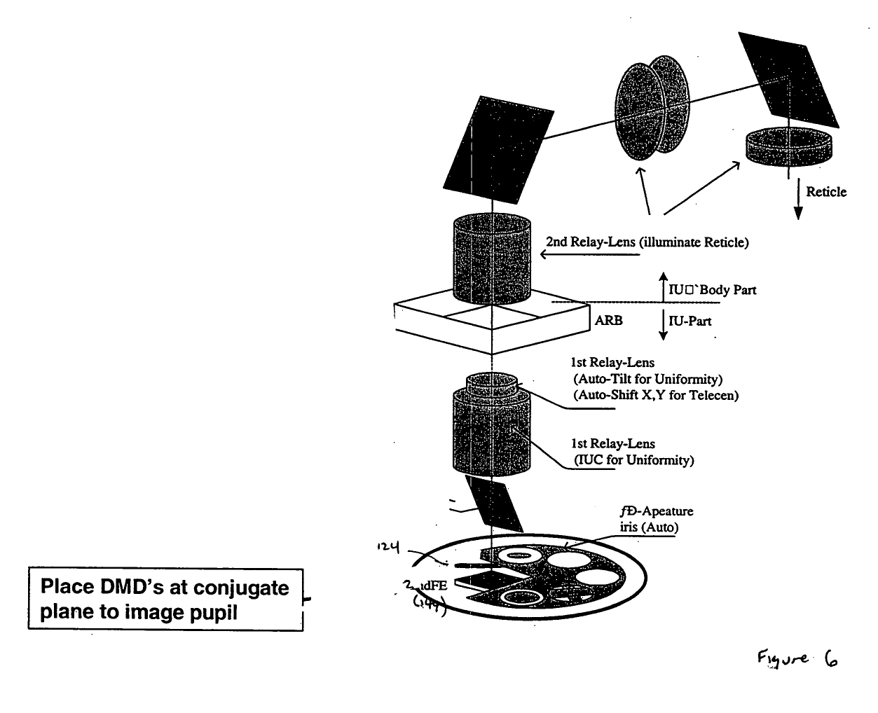

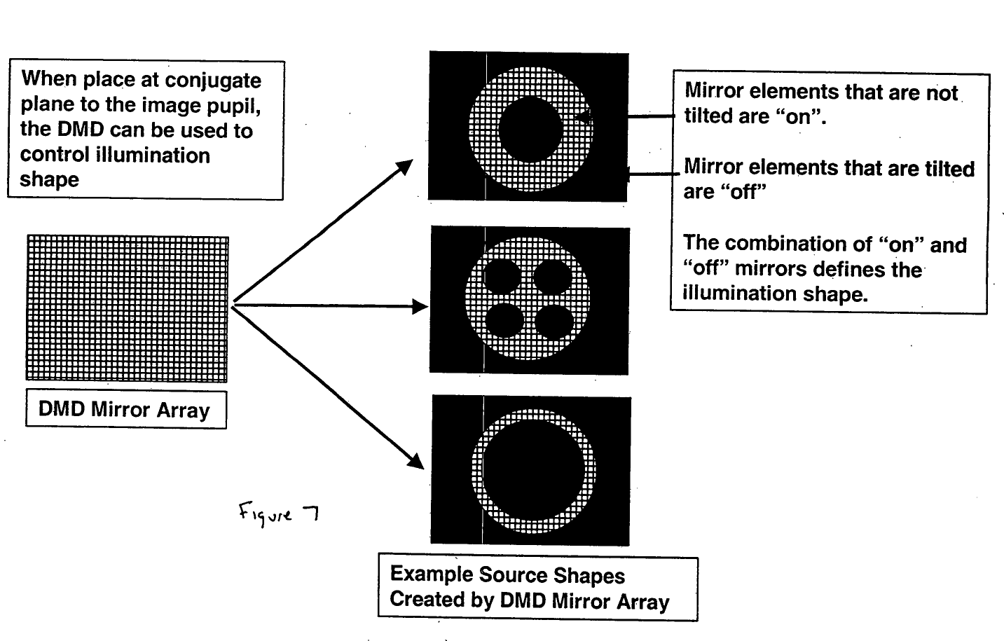

FIG. 5 shows steps implementing the method of the invention. The steps of FIG. 5 may equally represent a high level block diagram of the system of the invention, implementing the steps thereof. The steps of FIG. 5 may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation over the Internet or some other type of network.

At step 500, the light beam is illuminated onto the wafer stage. At step 505, the brightness of the light is measured throughout the illumination plane. At step 510, the data obtained in step 505 is analyzed to determine an illumination distribution. If the analysis determines that the illumination distribution meets predefined criteria such as having an illumination uniformity within certain limits, the process ends at “E”. If the analysis determines that the illumination distribution does meet predefined criteria, at step 515, the data is interpolated and used to adjust mirror(s) elements of the micro-mirror array at a defined tilt angle and time to achieve a certain, predetermined illumination uniformity (or a reduction in non-uniformity). At step 520, the mirror(s) are adjusted at a defined tilt angle and time to achieve the certain, predetermined illumination uniformity. The process ends at “E”.

By way of a more specific example, it is now possible to control the shape of the frequency modulation to control the imaging properties by tilting certain mirror elements lying in the conjugate plane (e.g., modulate the frequency plane of the image). Thus, it is now possible to flexibly control the source shape to modulate the frequency plane of an image.

In a simple example for illustrative purposes only,
A plurality of parallel lines in a repetitive pattern may be representative of a printed pattern, with the spacing of these lines having a certain frequency, where the frequency plane of the image is represented by two dots: a dot on the left and a dot on the right.
To print sharply in the frequency plane, the mirrors can be tilted to block out everything except the spot on the left and the spot on the right by allowing illumination of the light on these spots. This will, in turn, increase the resolution of these spots. Thus, depending on the desired printed shape, it is now possible to filter the frequency plane in a way that improves the resolution for the printed feature. Also, the need for the fixed aperture is now eliminated, which does not provide any modulation; instead, it allows all of the light through each of the holes, in a static fashion.

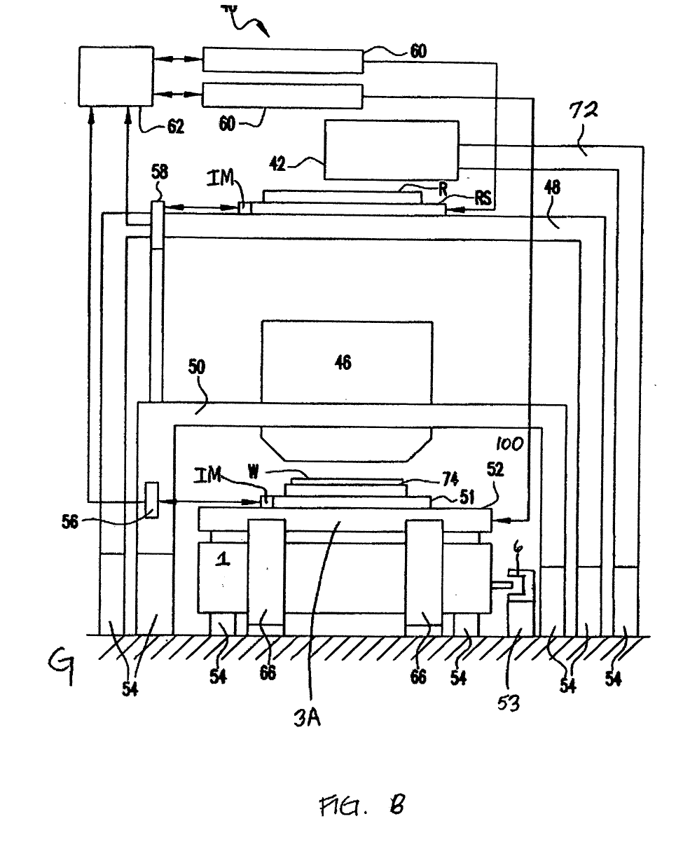

FIG. 8 is a schematic view illustrating a photolithography apparatus (exposure apparatus) 40 according to the present invention. The wafer positioning stage 52 includes a wafer stage 51, a base 1, a following stage base 3A, and an additional actuator 6. The wafer stage 51 comprises a wafer chuck 74 that holds a wafer W and an interferometer mirror IM. The base 1 is supported by a plurality of isolators 54. The isolator 54 may include a gimbal air bearing (not shown). The following stage base 3A is supported by a wafer stage frame (reaction frame) 66. The additional actuator 6 is supported on the ground G through a reaction frame 53. The wafer positioning stage 52 is structured so that it can move the wafer stage 51 in multiple (e.g., three to six) degrees of freedom under precision control by a drive control unit 60 and system controller 62, and position the wafer W at a desired position and orientation relative to the projection optics 46. In this embodiment, the wafer stage 51 has six degrees of freedom by utilizing the Z direction forces generated by the x motor and the y motor of the wafer positioning stage 52 to control a leveling of the wafer W. However, a wafer table having three degrees of freedom (z, ✓ₓ, ✓_{y}) or six degrees of freedom can be attached to the wafer stage 51 to control the leveling of the wafer. The wafer table includes the wafer chuck 74, at least three voice coil motors (not shown), and bearing system. The wafer table is levitated in the vertical plane by the voice coil motors and supported on the wafer stage 51 by the bearing system so that the wafer table can move relative to the wafer stage 51.

The reaction force generated by the wafer stage 51 motion in the X direction can be canceled by the motion of the base 1 and the additional actuator 6. Further, the reaction force generated by the wafer stage 51 motion in the Y direction can be canceled by the motion of the following stage base 3A.

An illumination system 42 is supported by a frame 72. The illumination system 42 projects radiant energy (e.g., light) through a mask pattern on a reticle R that is supported by and scanned using a reticle stage RS. The reaction force generated by motion of the reticle stage RS can be mechanically released to the ground through a reticle stage frame 48 and the isolator 54, in accordance with the structures described in JP Hei 8-330224 and U.S. Pat. No. 5,874,820, the entire contents of which are incorporated by reference herein. The light is focused through a projection optical system (lens assembly) 46 supported on a projection optics frame 50 and released to the ground through isolator 54.

An interferometer 56 is supported on the projection optics frame 50 and detects the position of the wafer stage 51 and outputs the information of the position of the wafer stage 51 to the system controller 62. A second interferometer 58 is supported on the projection optics frame 50 and detects the position of the reticle stage RS and outputs the information of the position to the system controller 62. The system controller 62 controls a drive control unit 60 to position the reticle R at a desired position and orientation relative to the wafer W or the projection optics 46.

In the embodiments of the present invention, the projections optics frame 50 is mounted to the ground at the cancellation point E by utilizing either three or four supporting devices 10. More particularly, the interferometer 56 and second interferometer 58 are both mounted to ground by the optics frame 50 (in addition to the projection optics 46) at the cancellation point E; that is, the interferometer 56 and second interferometer 58 (and projection optics 46) are mounted to ground by the optics frame 50 on supports located at points whereat the interference between at least two divided wavefronts is destructive. In addition, at least the reaction frame 53 and the wafer stage frame 66 correspond to the post 12 that is connected to the ground G at point A of FIG. 1. More specifically, the reaction frame 53, the wafer stage frame 66 as well as the wafer positioning stage 52 and the wafer stage 51 comprising the wafer chuck 74 that holds a wafer W and an interferometer mirror IM correspond to the post 12 that is connected to the ground G at point A of FIG. 1.

Further, any support members that can transmit the reaction forces or vibrations to the ground G, may be connected to the ground G at a point A of FIG. 1. For example, the frame 72 supporting the illumination system 42 and the reticle stage frame 48 can be connected to the ground G at point A of FIG. 1. If there are many members that should be connected to the ground G at point A, these members may be supported by a main support member that is connected to the ground G at point A instead of connecting each member to the ground G at point A. Oppositely, any support members that should be isolated from the reaction forces or vibrations, may be connected to the ground G at the cancellation point E for FIG. 3C. For example, the base 1 can be connected to the ground G at the cancellation point E with or without isolator 54. If there are many isolated members should be connected to the ground G. at the cancellation point E, these isolated members may be supported by a main isolated support member that is connected to the ground G at the cancellation point E, instead of connecting each isolated member to the ground G at the cancellation point E.

There are a number of different types of photolithographic devices. For example, apparatus 40 may comprise an exposure apparatus that can be used as a scanning type photolithography system which exposes the pattern from reticle R onto wafer W with reticle R and wafer W moving synchronously. In a scanning type lithographic device, reticle R is moved perpendicular to an optical axis of projection optics 46 by reticle stage RS and wafer W is moved perpendicular to an optical axis of projection optics 46 by wafer positioning stage 52. Scanning of reticle R and wafer W occurs while reticle R and W are moving synchronously in the x direction.

Alternately, exposure apparatus 40 can be a step-and-repeat type photolithography system that exposes reticle R while reticle R and wafer W are stationary. In the step and repeat process, wafer W is in a constant position relative to reticle R and projection optics 46 during the exposure of an individual field. Subsequently, between consecutive exposure steps, wafer W is consecutively moved by wafer positioning stage 52 perpendicular to the optical axis of projection optics 46 so that the next field of semiconductor wafer W is brought into position relative to projection optics 46 and reticle R for exposure. Following this process, the images on reticle R are sequentially exposed onto the fields of wafer W so that the next field of semiconductor wafer W is brought into position relative to projection optics 46 and reticle R.

However, the use of apparatus 40 provided herein is not limited to a photolithography system for semiconductor manufacturing. Apparatus 40 (e.g., an exposure apparatus), for example can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern by closely locating a mask and a substrate without the use of a lens assembly. Additionally, the present invention provided herein can be used in other devices, including other semiconductor processing equipment, machine tools, metal cutting machines, and inspection machines.

In the illumination system 42, the illumination source can be g-line (436 μm), i-line (365 nm), KrF excimer laser (248 nm), ArF excimer laser (193 nm) and F₂ laser (157 nm). Alternatively, the illumination source can also use charged particle beams such as x-ray and electron beam. For instance, in the case where an electron beam is used, thermionic emission type lanthanum hexaboride (LaB₆) or tantalum (Ta) can be used as an electron gun. Furthermore, in the case where an electron beam is used, the structure could be such that either a mask is used or a pattern can be directly formed on a substrate without the use of a mask.

With respect to projection optics 46, when far ultra-violet rays such as the excimer laser is used, glass materials such as quartz and fluorite that transmit far ultra-violet rays are preferably used. When the F₂ type laser or x-ray is used, projection optics 46 should preferably be either catadioptric or refractive (a reticle should also preferably be a reflective type), and when an electron beam is used, electron optics should preferably comprise electron lenses and deflectors. The optical path for the electron beams should be in a vacuum.

Also, with an exposure device that employs vacuum ultra-violet radiation (VUV) of wavelength 200 nm or lower, use of the catadioptric type optical system can be considered. Examples of the catadioptric type of optical system include the disclosure Japan Patent Application Disclosure No. 8-171054 published in the Official Gazette for Laid-Open Patent Applications and its counterpart U.S. Pat. No. 5,668,672, as well as Japanese Patent Application Disclosure No. 10-20195 and its counterpart U.S. Pat. No. 5,835,275. In these cases, the reflecting optical device can be a catadioptric optical system incorporating a beam splitter and concave mirror. Japanese Patent Application Disclosure No. 8-334695 published in the Official Gazette for Laid-Open Patent Applications and its counterpart U.S. Pat. No. 5,689,377 as well as Japanese Patent Application Disclosure No. 10-3039 and its counterpart U.S. Pat. No. 5,892,117 also use a reflecting-refracting type of optical system incorporating a concave mirror, etc., but without a beam splitter, and can also be employed with this invention. The disclosures in the above-mentioned U.S. patents, as well as the Japanese patent applications published in the Office Gazette for Laid-Open Patent Applications are incorporated herein by reference.

Further, in photolithography systems, when linear motors that differ from the motors shown in the above embodiments (see U.S. Pat. Nos. 5,623,853 or 5,528,118) are used in one of a wafer stage or a reticle stage, the linear motors can be either an air levitation type employing air bearings or a magnetic levitation type using Lorentz force or reactance force. Additionally, the stage could move along a guide, or it could be a guideless type stage that uses no guide. The disclosures in U.S. Pat. Nos. 5,623,853 and 5,528,118 are incorporated herein by reference.

Alternatively, one of the stages could be driven by a planar motor, which drives the stage by electromagnetic force generated by a magnet unit having two-dimensionally arranged magnets and an armature coil unit having two-dimensionally arranged coils in facing positions. With this type of driving system, either one of the magnet unit or the armature coil unit is connected to the stage and the other unit is mounted on the moving plane side of the stage.

Movement of the stages as described above generates reaction forces that can affect performance of the photolithography system. Reaction forces generated by the wafer (substrate) stage motion can be mechanically released to the floor (ground) by use of a frame member as described in U.S. Pat. No. 5,528,118 and published Japanese Patent Application Disclosure No. 8-166475. Additionally, reaction forces generated by the reticle (mask) stage motion can be mechanically released to the floor (ground) by use of a frame member as described in U.S. Pat. No. 5,874,820 and published Japanese Patent Application Disclosure No. 8-330224. The disclosures in U.S. Pat. Nos. 5,528,118 and 5,874,820 and Japanese Patent Application Disclosure No. 8-330224 are incorporated herein by reference.

As described above, a photolithography system according to the above described embodiments can be built by assembling various subsystems in such a manner that prescribed mechanical accuracy, electrical accuracy and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, total adjustment is performed to make sure that every accuracy is maintained in the complete photolithography system. Additionally, it is desirable to manufacture an exposure system in a clean room where the temperature and humidity are controlled.

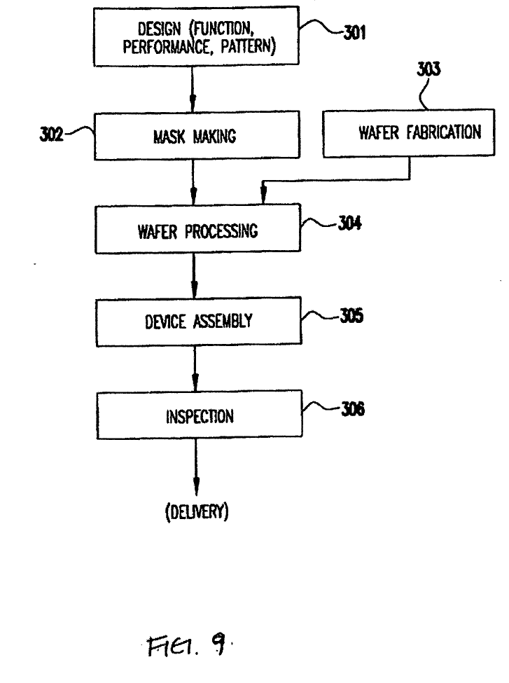

Further, semiconductor devices can be fabricated using the above described systems, by the process shown generally in FIG. 9. In step 301 the device's function and performance characteristics are designed. Next, in step 302, a mask (reticle) having a pattern is designed according to the previous designing step, and in a parallel step 303, a wafer is made from a silicon material. The mask pattern designed in step 302 is exposed onto the wafer from step 303 in step 304 by a photolithography system described hereinabove consistent with the principles of the present invention. In step 305 the semiconductor device is assembled (including the dicing process, bonding process and packaging process), then finally the device is inspected in step 306.

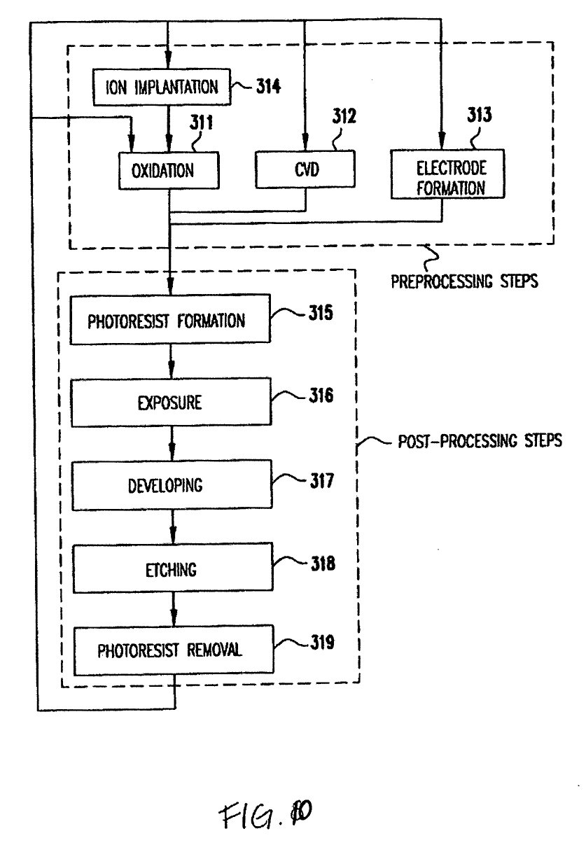

FIG. 10 illustrates a detailed flowchart example of the above-mentioned step 304 in the case of fabricating semiconductor devices. In step 311 (oxidation step), the wafer surface is oxidized. In step 312 (CVD step), an insulation film is formed on the wafer surface. In step 313 (electrode formation step), electrodes are formed on the wafer by vapor deposition. In step 314 (ion implantation step), ions are implanted in the wafer. The above-mentioned steps 311-314 form the preprocessing steps for wafers during wafer processing, and selection is made at each step according to processing requirements.

At each stage of wafer processing, when the above-mentioned preprocessing steps have been completed, the following post-processing steps are implemented. During post-processing, initially in step 315 (photoresist formation step), photoresist is applied to a wafer. Next, in step 316 (exposure step), the above-mentioned exposure apparatus is used to transfer the circuit pattern of a mask (reticle) to a wafer. Then, in step 317 (developing step), the exposed wafer is developed, and in step 318 (etching step), parts other than residual photoresist (exposed material surface) are removed by etching. In step 319 (photoresist removal step), unnecessary photoresist remaining after etching is removed. Multiple circuit patterns are formed by repetition of these pre-processing and post-processing steps.

Although the invention has been particularly discussed in a photolithography system as an exemplary example, the inventive products, methods and systems may be used in other and further contexts, including any applications where it is desired to reduce or minimize vibrations, such as precision apparatuses (e.g., photography systems).

While the invention has been described in terms of exemplary embodiments, those skilled in the art will recognize that the invention can be practiced with modification within the spirit and scope of the appended claims.

It is claimed:

1. A subsystem for a lithographic tool, comprising at least one array of controllable tilting mirrors placed in either an image reticle plane or a conjugate image plane to provide dynamic control of an illumination beam through an exposure field.

2. The subsystem of claim 1, wherein the at least one array of controllable tilting mirrors in the image reticle plane reduces illumination non-uniformity across the exposure field.

3. The subsystem of claim 1, wherein the at least one array of controllable tilting mirrors in the image reticle plane compensates for illumination uniformity drift.

4. The subsystem of claim 1, wherein the at least one array of controllable tilting mirrors in the image reticle plane compensates for illumination non-uniformity signatures across an illumination field and provides dynamic illumination control in the exposure field.

5. The subsystem of claim 4, wherein the at least one array of controllable tilting mirrors in the image reticle plane supports continuously adjustable uniformity feedback control.

6. The subsystem of claim 1, further comprising:
a sensor for sensing illumination intensity within areas of the exposure field; and
a feedback control in communication with the sensor for providing feedback to the at least one array of controllable tilting mirrors, in a continuously adjustable feedback control.

7. The subsystem of claim 1, further comprising a feedback control which interpolates illumination distribution data over the exposure field to provide illumination uniformity data used to control adjustment of the one or more mirrors of the at least one array of controllable tilting mirrors to reduce illumination non-uniformity over the exposure field.

8. The subsystem of claim 7, wherein the feedback control controls tilt time of the one or more mirrors to provide gray scale adjustments in the illumination field to dim any sensed bright spots in the illumination distribution.

9. The subsystem of claim 1, further comprising a sensor positioned between a fixed wheel turret and a relay lens, wherein
the sensor senses illumination intensity or power to determine a required exposure time needed to obtain a predetermined illumination intensity at the exposure field, and
the at least one array of controllable tilting mirrors positioned in the image reticle plane is positioned before the sensor or between the fixed wheel turret and the sensor to dynamically provide a reduction in illumination non-uniformity.

10. The subsystem of claim 1, wherein the array of controllable tilting mirrors includes two arrays of tilting mirrors.

11. The subsystem of claim 10, wherein the two arrays of tilting mirrors is positioned between an expansion optical subsystem and reduction optical subsystem.

12. The subsystem of claim 1, wherein the at least one array of controllable tilting mirrors in the conjugate image plane controls source shape.

13. The subsystem of claim 12, wherein the at least one array of controllable tilting mirrors in the conjugate image plane is an electronic aperture.

14. The subsystem of claim 12, wherein the at least one array of controllable tilting mirrors in the conjugate image plane controls the source shape to modulate the frequency plane of an image.

15. The subsystem of claim 1, wherein the at least one array of controllable tilting mirrors in the conjugate image plane filters a frequency plane to improve a resolution for a printed feature.

16. A subsystem for a lithographic tool, comprising:
an optical subsystem and a plurality of mirrors directing light to a reticle;
an array of tilting mirrors placed in an image reticle plane of the light;
a sensor for sensing the illumination distribution of the light at a wafer stage; and
a control for interpolating data of the illumination distribution sensed by the sensor, and controlling movement of at least one mirror of the array of mirrors based on the interpolated data.

17. The subsystem of claim 16, wherein the control reduces illumination non-uniformity by providing instructions to move the at least one mirror to reflect light away from the reticle.

18. The subsystem of claim 17, wherein the control controls tilt time of the at least one mirror to provide gray scale adjustments in an illumination field to adjust for any sensed bright spots at the wafer stage.

19. A subsystem for a lithographic tool, comprising:
an optical subsystem and a plurality of mirrors directing light to an exposure field; and
an array of tilting mirrors placed in a conjugate image plane of the light to control the source shape to modulate the frequency plane of an image.

20. A method for reducing illumination non-uniformity, comprising the steps of:
illuminating an exposure field with light;
measuring brightness of the light throughout the exposure field;
interpolating the measured brightness to provide data of illumination uniformity over the exposure field; and
adjusting at least one mirror element based on the data to manipulate the light thereby reducing illumination non-uniformity as measured in the measuring step.

21. The method of claim 20, wherein the at least one mirror element is adjusted at a defined time to reduce the illumination non-uniformity and achieve a predetermined illumination uniformity.

22. The method of claim 20, wherein the adjusting step provides gray scale in portions of the exposure field by adjusting tilt cycling time of the at least one mirror element.

23. The method of claim 20, wherein when the illumination distribution exceeds a predefined limit, the interpolating step provides data of illumination uniformity within the predefined limit and the adjusting step adjusts the at least one mirror element to within the predefined limit to thereby reduce illumination non-uniformity.

24. An exposure apparatus, comprising:
an illumination system that projects radiant energy on a reticle R that is supported by and scanned using a wafer positioning stage;
at least one linear motor that positions the wafer positioning stage; and
at least one array of tilting mirrors placed in either an image reticle plane or a conjugate image plane of the illumination system to provide dynamic control of an illumination beam through an exposure field.

25. A device manufactured with the exposure apparatus of claim 24.

26. A wafer on which an image has been formed by the exposure apparatus of claim 24.

27. The exposure apparatus of claim 24, wherein the at least one array of tilting mirrors in the image reticle plane reduces illumination non-uniformity across the exposure field and supports continuously adjustable feedback control.

28. The exposure apparatus of claim 24, further comprising a feedback control which interpolates illumination distribution over the exposure field and controls adjustment of the one or more mirrors of the at least one array of tilting mirrors to reduce illumination non-uniformity in the exposure field, wherein the feedback control controls tilt time of the one or more mirrors to provide gray scale adjustments.

29. The exposure apparatus of claim 24, wherein the at least one array of tilting mirrors in the conjugate image plane controls source shape.
